(19) United States
(12) Patent Application Publication
(10) Pub. No.: US 2016/0039031 A1
(43) Pub. Date: Feb. 11, 2016

(54) CERAMIC-METAL BONDING STRUCTURE AND PROCESS FOR PRODUCING SAME

(71) Applicant: PANASONIC INTELLECTUAL PROPERTY MANAGEMENT CO., LTD., Osaka-shi, Osaka (JP)

(72) Inventors: Takashi SHINDO, Osaka (JP); Masahiro SATO, Nara (JP); Hiroyuki YOSHIDA, Kyoto (JP); Naoki KINOSHITA, Mie (JP); Kentarou HIRAYAMA, Osaka (JP); Naoki SEKI, Mie (JP)

(21) Appl. No.: 14/780,517

(22) PCT Filed: Mar. 20, 2014
(86) PCT No.: PCT/JP2014/001624

§ 371 Date: Sep. 25, 2015

(30) Foreign Application Priority Data
Mar. 27, 2013 (JP) 2013-067098

(51) Int. Cl. B23K 1/00; B23K 31/02; B32B 7/12; B32B 9/00; B32B 15/04

(52) U.S. Cl. CPC B23K 1/0008; B32B 9/005; B32B 15/04; B32B 7/12; B23K 31/02; B32B 2457/00

(57) ABSTRACT

The ceramic-metal bonding structure in accordance with the present invention includes: a ceramic member of an oxide ceramic; a metallic member which is mainly made of Fe and contains Ni and includes an end; an adhesive layer formed on the ceramic member; and a brazing material. The brazing material bonds the adhesive layer and the end of the metallic member. The adhesive layer contains an active metal capable of reacting with the oxide ceramic and has a thickness of equal to or less than 1.5 μm. An intermetallic compound of the active metal and the Ni exists inside the brazing material so as to be between the adhesive layer and the end of the metallic member.

### TECHNICAL FIELD

The present invention relates to a ceramic-metal bonding structure and a process for producing the same.

### BACKGROUND ART

There has been used in various fields a ceramic-metal bonding structure including a ceramic member of ceramic material and a metallic member of a metal material which are brazed with each other. The ceramic-metal bonding structure, for example, may be used for casings of an electromagnetic relay, a vacuum switch, and an electronic component.

FIG. 8 shows a known example of such a ceramic-metal bonding structure, and in this example, a metallic member 103 and a ceramic member 102 are bonded while a reaction layer 104 in contact with the ceramic member 102 and a brazing material 105 in contact with the metallic member 103 are present between the metallic member 103 and the ceramic member 102 (e.g., see JP 2001-220253 A (hereinafter referred to as Patent Literature 1)).

In a metal-ceramic bonding structure 100 which is a ceramic-metal bonding structure disclosed in Patent Literature 1, the metallic member 103 contains Ni. In the metal-ceramic bonding structure 100, the reaction layer 104 contains one or more types of active metals selected from Ti, Zr and Hf. The metal-ceramic bonding structure 100 is produced by a first brazing step and a subsequent second brazing step. In the first brazing step, the reaction layer 104 is formed on the ceramic member 102 by metallization. In the second brazing step, the metallic member 103 and the ceramic member 102 are bonded with the brazing material 105.

Patent Literature 1 states that an intermetallic compound containing an active metal and Ni is suppressed from being formed inside the brazing material 105 of the metal-ceramic bonding structure 100, and bonding between the metallic member 103 and the ceramic member 102 is stabilized and strengthened.

There is demand for a ceramic-metal bonding structure formed by use of a smaller amount of brazing material. The process of producing the metal-ceramic bonding structure 100 of Patent Literature 1 requires the first brazing step and the second brazing step, and therefore it tends to be difficult to decrease usage amounts of materials for the reaction layer 104 and the brazing material 105. Moreover, in the metal-ceramic bonding structure 100 of Patent Literature 1, when the usage amounts of materials for the reaction layer 104 and the brazing material 105 are decreased, a size of fillet of the brazing material 105 is likely to decrease, which may possibly cause phenomenon that the fillet of the brazing material 105 partially shrinks (hereinafter referred to as shrinkage of fillet). In the metal-ceramic bonding structure 100, when the shrinkage of fillet of the brazing material 105 occurs, bonding reliability between the metallic member 103 and the ceramic member 102 may deteriorate.

### SUMMARY OF THE INVENTION

The present invention has been made in view of the above circumstances, and an object thereof is to propose a ceramic-metal bonding structure which is higher in bonding reliability and a process for producing the same.

The first aspect of a ceramic-metal bonding structure according to the present invention includes a ceramic member of an oxide ceramic, a metallic member which is mainly made of Fe and contains Ni and includes an end, an adhesive layer formed on the ceramic member, a brazing material bonding the adhesive layer and the end of the metallic member. The adhesive layer contains an active metal capable of reacting with the oxide ceramic and has a thickness of equal to or less than 1.5 μm. An intermetallic compound of the active metal and the Ni exists inside the brazing material so as to be between the adhesive layer and the end of the metallic member.

In the second aspect of the ceramic-metal bonding structure according to the present invention, realized in combination with the first aspect, the metallic member is made of a Fe—Ni alloy which contains equal to or less than 30% by weight of Ni.

The first aspect of a process for producing a ceramic-metal bonding structure according to the present invention includes a preparation step, an applying step, a placing step and a brazing step. In the preparation step, a ceramic member of an oxide ceramic, a paste material containing an active metal capable of reacting with the oxide ceramic, a metallic member which is mainly made of Fe and contains Ni, and a metal material containing Ag are prepared. In the applying step, the paste material is applied to the ceramic member. In the placing step, the metal material is placed on the paste material and an end of the metallic member is placed on the metal material. In the brazing step, the adhesive layer and the end of the metallic member are bonded, by forming: an adhesive layer on the ceramic member by reacting the active metal contained in the paste material with the oxide ceramic; and a brazing material by melting the metal material, by heating under reduced pressure.

In the second aspect of the process for producing a ceramic-metal bonding structure according to the present invention, realized in combination with the first aspect of the process for producing the same, the paste material contains a powder of the active metal which has an average particle size of equal to or less than 10 μm and, in the applying step, the paste material is applied to the ceramic member so as to form a layer having a thickness of equal to or less than 20 μm.

In the third aspect of the process for producing a ceramic-metal bonding structure according to the present invention, realized in combination with the first or the second aspect of the process for producing the same, the active metal is any one of Ti, Zr and Hf.

In the fourth aspect of the process for producing a ceramic-metal bonding structure according to the present invention, realized in combination with first or the second aspect of the process for producing the same, the paste material contains 25% to 35% by weight of TiH₂.

In the fifth aspect of the process for producing a ceramic-metal bonding structure according to the present invention, realized in combination with any one of the first to the fourth aspects of the process for producing the same, in the brazing step, the paste material and the metal material are heated under a pressure of equal to or less than 10⁻¹ Pa at a temperature in a range of 800° C. to 850° C.

In the sixth aspect of the process for producing a ceramic-metal bonding structure according to the present invention, realized in combination with any one of the first to the fifth aspects of the process for producing, in the brazing step, heating is conducted so as to form an intermetallic compound of the active metal and Ni derived from the metallic member inside the brazing material so as to be between the ceramic member and the metallic member.

### BRIEF DESCRIPTION OF THE DRAWINGS

FIG. 1 is a schematic sectional view illustrating a ceramic-metal bonding structure of one embodiment.

FIGS. 2A to 2E each are a process chart explaining a process for producing the ceramic-metal bonding structure of the embodiment.

FIG. 3 is a schematic sectional view illustrating another ceramic-metal bonding structure of the embodiment.

FIG. 4 is a schematic sectional view illustrating a ceramic-metal bonding structure of Comparative Example 1.

FIGS. 5A to 5F each are a process chart explaining a process for producing the ceramic-metal bonding structure of Comparative Example 1.

FIG. 6 is a schematic sectional view illustrating a ceramic-metal bonding structure of Comparative Example 2.

FIG. 7 is a schematic sectional view illustrating a ceramic-metal bonding structure of Comparative Example 3.

FIG. 8 is an enlarged schematic view illustrating a conventional metal-ceramic bonding structure.

### DESCRIPTION OF EMBODIMENTS

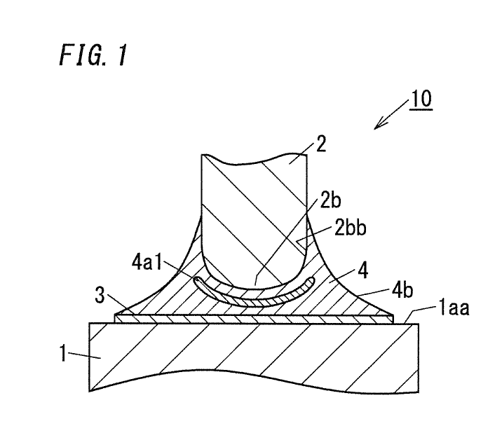

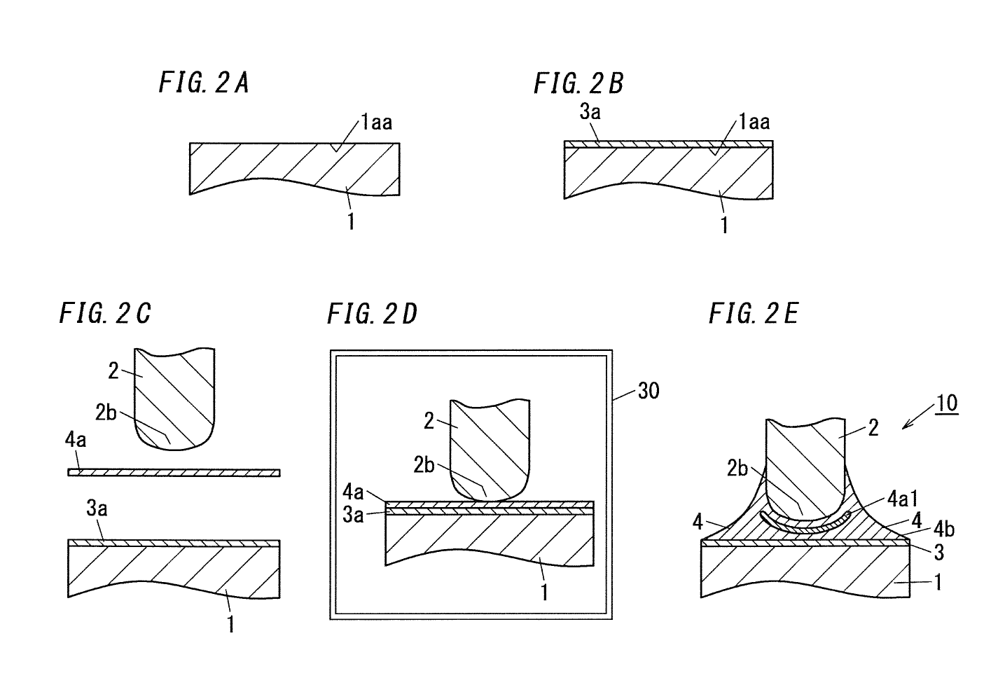

A ceramic-metal bonding structure 10 of the present embodiment will be described based on FIG. 1 and a process for producing the ceramic-metal bonding structure 10 will be described based on FIGS. 2A to 2E. Note that same members are respectively denoted by same numbers in figures.

In the ceramic-metal bonding structure 10 of the present embodiment, a ceramic member 1 and a metallic member 2 are bonded by an adhesive layer 3 and a brazing material 4, which will be described below. The ceramic member 1 is made of an oxide ceramic. The metallic member 2 is mainly made of Fe and contains Ni. In other words, the metallic member 2 mainly contains Fe and further contains Ni. The ceramic-metal bonding structure 10 includes the adhesive layer 3 containing an active metal capable of reacting with the oxide ceramic, bonding the ceramic member 1 and the brazing material 4, and having a thickness of equal to or less than 1.5 μm on a surface 1aa of the ceramic member 1. The brazing material 4 is in contact with the adhesive layer 3 and a bonding end 2b (end) of the metallic member 2. The ceramic-metal bonding structure 10 includes an intermetallic compound 4a1 of the active metal and the Ni which is present inside the brazing material 4 so as to extend along an edge of the bonding end 2b.

Hence, the ceramic-metal bonding structure 10 of the present embodiment can be higher in bonding reliability.

More specifically, in the ceramic-metal bonding structure 10 of the present embodiment, the oxide ceramic is used as material of the ceramic member 1. The oxide ceramic may be a ceramic material having a content by percentage of alumina (AI₂O₃) being 92%. Note that the ceramic member 1 of the present embodiment may contain alumina and further contain silicon oxide, calcium oxide, magnesium oxide, barium oxide, boron oxide, zirconium oxide and the like which may be derived from a sintering additive used for a green sheet (not shown) which is a basis of the ceramic member 1. The adhesive layer 3 containing Ti as the active metal is formed on the surface 1aa of the ceramic member 1. The adhesive layer 3 contains the active metal capable of reacting with the oxide ceramic. The adhesive layer 3 having a thickness of equal to or less than 1.5 μm is formed on the surface 1aa of the ceramic member 1. In the ceramic-metal bonding structure 10 of the present embodiment, for example, the adhesive layer 3 having a thickness of 1 μm is formed on the surface 1aa of the ceramic member 1. Note that, as for the ceramic-metal bonding structure 10, for example, a thickness of the adhesive layer 3 may be measured with an electron probe micro analyzer (EPMA), an energy dispersive X-ray analyzer (EDX) or the like.

A metal material which is mainly made of Fe and contains Ni is used for material of the metallic member 2. In the present embodiment, an Fe—Ni alloy which contains equal to or less than 30% by weight of Ni is used for the metallic member 2. In other words, it is preferable that the metallic member 2 is made of the Fe—Ni alloy which contains equal to or less than 30% by weight of Ni. The metallic member 2 may be made of an Fe—Ni—Co alloy. The Fe—Ni—Co alloy of the metallic member 2 may be, for example, an alloy which contains 53.5% by weight of Fe, 29% by weight of Ni, 17% by weight of Co, 0.2% by weight of Si and 0.3% by weight of Mn. When viewed from a cross section, the bonding end 2b of the metallic member 2 is formed into a convex shape protruding toward the ceramic member 1 by a pressing process or the like. In the ceramic-metal bonding structure 10 of the present embodiment, the ceramic member 1 is made to be larger than the bonding end 2b of the metallic member 2 when viewed from a cross section.

In the ceramic-metal bonding structure 10, the adhesive layer 3 and the bonding end 2b of the metallic member 2 are bonded with the brazing material 4. That is, the ceramic member 1 and the metallic member 2 are bonded with the brazing material 4 and the adhesive layer 3. In the present embodiment, the brazing material 4 contains Ag. A material of the brazing material 4 may be a silver solder which is an Ag—Cu based alloy which is an Ag—Cu alloy. The silver solder being the Ag—Cu based alloy may be a silver solder of JIS-Z3261 (BAg-8 (Ag:Cu=18:7)). The ceramic-metal bonding structure 10 includes the intermetallic compound 4a1 inside the brazing material 4 and between the bonding end 2b of the metallic member 2 and the surface 1aa of the ceramic member 1. The intermetallic compound 4a1 is, for example, a segregation layer of metal constituted by Ti being the active metal and Ni in the metallic member 2 which are segregated inside the brazing material 4. In the ceramic-metal bonding structure 10, the brazing material 4 is in contact with the adhesive layer 3 and the edge of the bonding end 2b of the metallic member 2 while the intermetallic compound 4a1 extends along the edge of the bonding end 2b of the metallic member 2. That is, in the ceramic-metal bonding structure 10, the ceramic member 1 and the metallic member 2 are bonded by the adhesive layer 3 and the brazing material 4. In the present embodiment, the ceramic-metal bonding structure 10 includes a fillet 4b of the brazing material 4, which has a flared shape toward the ceramic member 1 from the metallic member 2. In the ceramic-metal bonding structure 10 of the present embodiment, the metallic member 2 and the adhesive layer 3 are bonded so that the bonding end 2b of the metallic member 2 is covered with the brazing material 4 in a way a fillet formation region 2bb of the metallic member 2 is buried in the fillet 4b of the brazing material 4.

Hereinafter, a process for producing the ceramic-metal bonding structure 10 described above will be explained with reference to FIGS. 2A to 2E.

In the process for producing the ceramic-metal bonding structure 10 of the present embodiment, the ceramic member 1 having the surface 1aa which is smooth and to be a bonding surface is prepared in advance (refer to FIG. 2A). The ceramic member 1 is made of the oxide ceramic. Specifically, the process for producing the ceramic-metal bonding structure 10 of the present embodiment includes a preparation step, and in the preparation step, the ceramic member 1 of the oxide ceramic, a paste material 3a containing the active metal capable of reacting with the oxide ceramic, the metallic member 2 which is mainly made of Fe and contains Ni, and a metal material 4a containing Ag are prepared.

Next, the process for producing the ceramic-metal bonding structure 10 includes an applying step (see FIG. 2B) of applying the paste material 3a which is a basis of the adhesive layer 3 containing Ti as the active metal capable of reacting with the oxide ceramic to the surface 1aa of the ceramic member 1. The paste material 3a is to be the adhesive layer 3 in a brazing step described below. The paste material 3a contains Ti as a powder of the active metal which has an average particle size of equal to or less than 10 μm. The powder may be, for example, a powder of TiH₂ which has an average particle size of 5 μm. The paste material 3a may be an organic binder which contains 30% by weight of the powder of TiH₂. The powder of TiH₂ may be, for example, formed by a gas evaporation method. In the gas evaporation method, metal hydride particles may be generated with an H₂ gas as an atmosphere gas. Particles having an average particle size in a range of 5 nm to 1 μm may be formed by the gas evaporation method. Moreover, the powder of TiH₂ may also be, for example, formed by hydrogenation of a titanium material as a raw material made of a pure titanium chip. The powder of TiH₂ may be classified with a screen so as to have the average particle size of equal to or less than 10 μm. The powder of TiH₂ may also be classified by an appropriate method such as a settling method and the like so as to have the average particle size of equal to or less than 10 μm. Note that the average particle size refers to a 50% average particle size (d50) measured with a laser diffraction particle size distribution analyzer. The laser diffraction particle size distribution analyzer is a measurement based on a sphere equivalent diameter by a laser light scattering method, and thereby the average particle size of the powder of TiH₂ can be measured.

The paste material 3a may contain Sn—Ag—Cu particles besides the powder of TiH₂. Note that the active metal contained in the paste material 3a is not limited to Ti. The active metal may be any one of Ti, Zr and Hf. In the applying step, for example, the paste material 3a is applied to the ceramic member 1 so as to form a layer having a thickness of 15 μm. The process for producing the ceramic-metal bonding structure 10 of the present embodiment includes a screen printing step of printing the paste material 3a containing the powder of TiH₂ onto the surface 1aa. By the screen printing, it can be relatively easy to apply the paste material 3a to the surface 1aa of the ceramic member 1. The paste material 3a which is the basis of the adhesive layer 3 may be applied by not only the screen printing but also dispensing. That is, the process for producing the ceramic-metal bonding structure 10 of the present embodiment includes the applying step. In the applying step, the paste material 3a is applied to the ceramic member 1.

Next, the process for producing the ceramic-metal bonding structure 10 includes placing the metal material 4a which is a basis of the brazing material 4 on the paste material 3a applied to the ceramic member 1 (see FIG. 2C). In the process for producing the ceramic-metal bonding structure 10, the metal material 4a may be placed on the paste material 3a with a brazing fixture for positioning (not shown). The paste material 3a is present between the ceramic member 1 and the metal material 4a, and the end 2b of the metallic member 2 is placed on the metal material 4a. The metal material 4a may be, for example, a metal foil having a thickness of 0.1 mm. The metal material 4a containing Ag is a basic material of the brazing material 4 and may be, for example, the Ag—Cu based alloy (Ag:Cu=18:7). That is, the metal material 4a is to be the brazing material 4 in the brazing step described below. The process for producing the ceramic-metal bonding structure 10 includes a placing step of placing the end 2b of the metallic member 2 on the paste material 3a applied to the ceramic member 1 with the metal material 4a containing Ag in-between. In other words, in the placing step, the metal material 4a is placed on the paste material 3a and the end 2b of the metallic member 2 is placed on the metal material 4a.

Next, in the process for producing the ceramic-metal bonding structure 10, the ceramic member 1 and the metallic member 2 are housed in a heating furnace 30 together with the brazing fixture for positioning to mount and fix the metallic member 2 on the metal material 4a (see FIG. 2D). In the process for producing the ceramic-metal bonding structure 10 of the present embodiment, the inside of the heating furnace 30 is under reduced pressure atmosphere, and heat treatment is performed while the metallic member 2 is kept in contact with the ceramic member 1. In the process for producing the ceramic-metal bonding structure 10, in the brazing step for brazing, the ceramic member 1 and the metallic member 2 are left under predetermined atmosphere at a predetermined temperature for a predetermined time in the heating furnace 30. That is, the process for producing the ceramic-metal bonding structure 10 of the present embodiment includes the brazing step. In the brazing step, in a state that the end 2b of the metallic member 2 is in contact with the metal material 4a, the ceramic member 1, the metallic member 2, the paste material 3a and the metal material 4a are heated under reduced pressure.

In the process for producing the ceramic-metal bonding structure 10 of the present embodiment, the brazing step is performed under a condition where a degree of vacuum in the heating furnace 30 is set to correspond to reduced pressure atmosphere of equal to or less than 1.0×10⁻¹ Pa (for example, 1.0×10⁻³ Pa). In the process for producing the ceramic-metal bonding structure 10, the condition of the brazing step may be that a heating temperature in the heating furnace 30 is 820° C. In the process for producing the ceramic-metal bonding structure 10 of the present embodiment, the brazing step is performed under a condition where a continuous time for heating in the heating furnace 30 is 10 minutes.

In the process for producing the ceramic-metal bonding structure 10 of the present embodiment, in order to form the brazing material 4 containing Ag by melting the metal material 4a, a heating temperature in the brazing step preferably falls within a range of 800° C. to 850° C.

In the process for producing the ceramic-metal bonding structure 10, when a heating temperature is lower than 800° C., solderability of the brazing material 4 tends to be insufficient, and also when a heating temperature is higher than 850° C., the solderability of the brazing material 4 tends to be too high. When the solderability of the brazing material 4 is too high in the process for producing the ceramic-metal bonding structure 10, the brazing material 4 tends to climb up excessively the metallic member 2. In the process for producing the ceramic-metal bonding structure 10, when the brazing material 4 containing the Ag—Cu alloy is formed by melting the metal material 4a, the continuous time for heating in the brazing step more preferably falls within a range of 5 and 30 minutes.

In the process for producing the ceramic-metal bonding structure 10, the brazing step is preferably performed under reduced pressure atmosphere and the degree of vacuum in the brazing step is preferably equal to or less than 1.0×10⁻¹ Pa. When the brazing step is performed under a condition where the degree of vacuum in the reduced pressure atmosphere is over 1.0×10⁻¹ Pa, it is liable to cause wetting failure of the paste material 3a. In the brazing step, when a heat treatment is performed in atmosphere, the active metal contained in the paste material 3a might be oxidized or nitrided. When the adhesive layer 3 is formed by the paste material 3a containing the active metal which is oxidized or nitrided, it tends to be difficult to form the adhesive layer 3 which is stable without variations in characteristics. That is, in the process for producing the ceramic-metal bonding structure 10, the heat treatment is performed in reduced pressure atmosphere after the placing step. Regarding the process for producing the ceramic-metal bonding structure 10, the active metal contained in the paste material 3a is diffused into the oxide ceramic by the heat treatment, and thereby the adhesive layer 3 on the ceramic member 1 is formed to bond the ceramic member 1 and the brazing material 4. Moreover, in the process for producing the ceramic-metal bonding structure 10, by the heat treatment, the metal material 4a is melted while the adhesive layer 3 is formed on the ceramic member 1. The process for producing the ceramic-metal bonding structure 10 includes the brazing step for brazing the adhesive layer 3 on the ceramic member 1 and the end 2b of the metallic member 2 by the heat treatment. That is, in the brazing step, the adhesive layer 3 and the metallic member 2 are bonded by forming: an adhesive layer 3 on the ceramic member 1 by reacting the active metal contained in the paste material 3 with the oxide ceramic; and the brazing material 4 by melting the metal material 4a, by heating under reduced pressure.

According to the process for producing the ceramic-metal bonding structure 10, the ceramic member 1 and the metallic member 2 may be bonded by the brazing material 4 formed by melting the metal material 4a, and the adhesive layer 3. The adhesive layer 3 is formed on the surface 1aa of the ceramic member 1 by the brazing step in the process for producing the ceramic-metal bonding structure 10 of the present embodiment, and also the brazing material 4 including the fillet 4b is formed by melting the metal material 4a in the brazing step.

In the process for producing the ceramic-metal bonding structure 10, after completion of the brazing step, the ceramic-metal bonding structure 10 is taken out from the heating furnace 30 and the brazing fixture is taken off. In the process for producing the ceramic-metal bonding structure 10 of the present embodiment, the ceramic-metal bonding structure 10 in which the brazing material 4 is in contact with the adhesive layer 3 and the bonding end 2b may be produced (refer to FIG. 2E). That is, in the process for producing the ceramic-metal bonding structure 10 of the present embodiment, the ceramic-metal bonding structure 10 in which the ceramic member 1 and the metallic member 2 are bonded may be produced by bonding the adhesive layer 3 and the metallic member 2 with the brazing material 4.

In the process for producing the ceramic-metal bonding structure 10 of the present embodiment, by the brazing step, the metal material 4a is melted, and therefore the brazing material 4 is formed and the paste material 3a becomes the adhesive layer 3 containing the active metal. In the process for producing the ceramic-metal bonding structure 10, the active metal reacts with the ceramic material (the oxide ceramic) on an interface (the interface between the ceramic member 1 and the paste material 3a) of the surface 1aa of the ceramic member 1 by accompanying the brazing step. In the process for producing the ceramic-metal bonding structure 10 of the present embodiment, the active metal contained in the adhesive layer 3 is excellent in affinity to either the ceramic material for the ceramic member 1 or metal components in the brazing material 4. Therefore, in the process for producing the ceramic-metal bonding structure 10, the adhesive layer 3 can securely bond the brazing material 4 and the ceramic member 1.

In other words, in the process for producing the ceramic-metal bonding structure 10 of the present embodiment, the ceramic member 1 of the oxide ceramic and the metallic member 2 which is mainly made of Fe and contains Ni are bonded by the adhesive layer 3 and the brazing material 4. The process for producing the ceramic-metal bonding structure 10 includes the applying step of the applying the paste material 3a containing the active metal capable of reacting with the oxide ceramic to the ceramic member 1. The process for producing the ceramic-metal bonding structure 10 includes the placing step of placing the metal material 4a containing Ag on the paste material 3a applied on the ceramic member 1 and the bonding end 2b of the metallic member 2 on the metal material 4a. Further, the process for producing the ceramic-metal bonding structure 10 includes the brazing step for brazing the adhesive layer 3 on the ceramic member 1 and the bonding end 2b of the metallic member 2 by melting the metal material 4a. In the brazing step, the paste material 3a and the metal material 4a are heat-treated under reduced pressure atmosphere of 1×10⁻¹ Pa at a temperature in a range of 800° C. to 850° C. Moreover, in the process for producing the ceramic-metal bonding structure 10, the paste material 3a is applied to the ceramic member 1 so as to form a layer having a thickness of equal to or less than 20 μm prior to the brazing step. The paste material 3a contains the powder of the active metal which has the average particle size of equal to or less than 10 μm and also 25% to 35% by weight of TiH₂ in the process for producing the ceramic-metal bonding structure 10 of the present embodiment.

Accordingly, the process for producing the ceramic-metal bonding structure 10 of the present embodiment can produce the ceramic-metal bonding structure 10 which is further higher in the bonding reliability. Although not shown, when the ceramic-metal bonding structure 10 of the present embodiment is used, for example, as a casing of an electromagnetic relay, the ceramic-metal bonding structure 10 of the present embodiment can be formed by bonding the ceramic member 1 having a hollow prism shape and the metallic member 2 having a hollow prism shape with a bottom with the brazing material 4. In this ceramic-metal bonding structure 10, the metallic member 2 having the hollow prism shape with a bottom may be bonded with the brazing material 4 so as to close an open end of the ceramic member 1 having the hollow prism shape. Note that, the ceramic-metal bonding structure 10 of the present embodiment is not limited to a structure where the metallic member 2 is provided so as to extend in a direction perpendicular to the surface 1aa of the ceramic member 1.

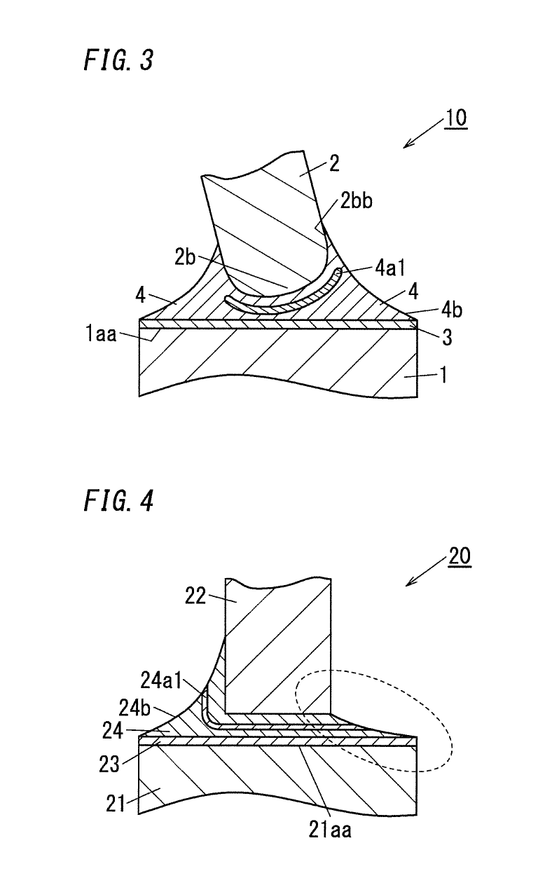

In the ceramic-metal bonding structure 10 of the present embodiment, as shown in FIG. 3, the ceramic member 1 and the metallic member 2 may be bonded so that the metallic member 2 is provided inclined relative to a normal line of the surface 1aa of the ceramic member 1. In the ceramic-metal bonding structure 10 of the present embodiment, even when the metallic member 2 is provided inclined relative to the normal line of the surface 1aa of the ceramic member 1, it is possible to suppress occurrence of shrinkage of the fillet 4b in part of the brazing material 4. In other words, it is possible to suppress decrease in size of the fillet 4b of the brazing material 4.

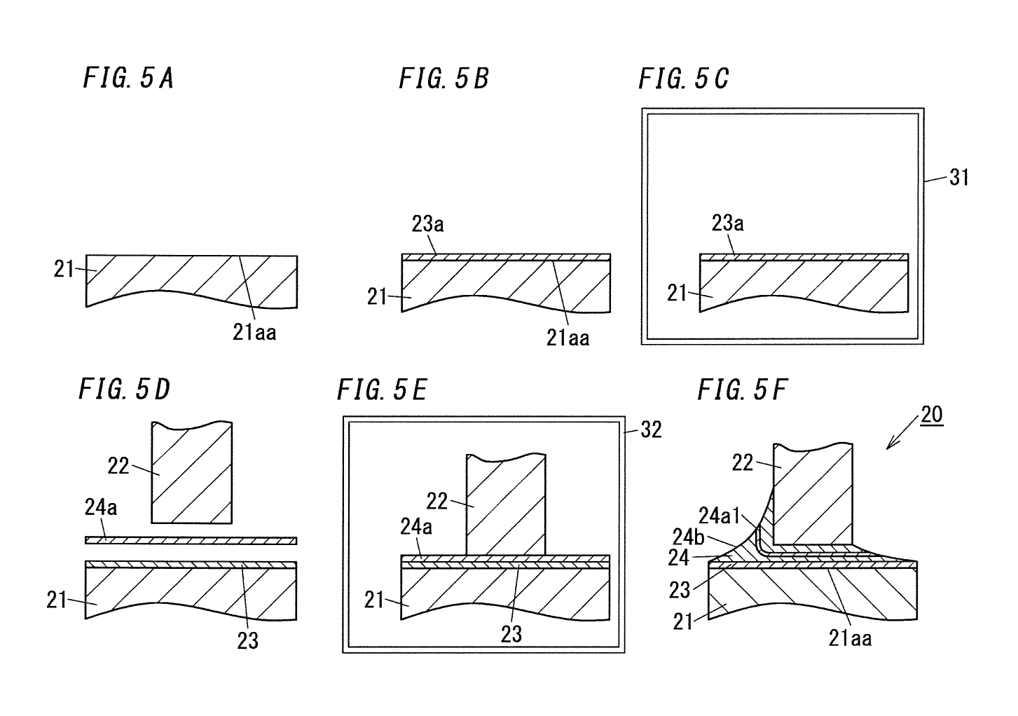

Next, it will be explained that the ceramic-metal bonding structure 10 produced by the process for producing the ceramic-metal bonding structure 10 of the present embodiment has increased bonding reliability, with reference to Comparative Example 1 shown in FIG. 4 and FIGS. 5A to 5F. In a ceramic-metal bonding structure 20 of Comparative Example 1, a ceramic member 21 including a reaction layer 23 and a metallic member 22 are bonded by a brazing material 24.

In a process for producing the ceramic-metal bonding structure 20 of Comparative Example 1, first of all, the ceramic member 21 including a surface 21aa which is smooth is prepared (see FIG. 5A). Regarding the ceramic member 21, a ceramic material for the ceramic member 21 is the same as the ceramic material for the ceramic member 1 in the present embodiment.

Next, in the process for producing the ceramic-metal bonding structure 20 of Comparative Example 1, a paste material 23a which is a basis of the reaction layer 23 containing Ti as an active metal is formed on the surface 21aa (see FIG. 5B). The paste material 23a is the same as the paste material 3a of the present embodiment.

Then, in the process for producing the ceramic-metal bonding structure 20 of Comparative Example 1, the ceramic member 21 having the surface 21aa on which the paste material 23a having a thickness of 100 μm is formed is taken in a heating furnace 31 and heat-treated (see FIG. 5C). In the process for producing the ceramic-metal bonding structure 20 of Comparative Example 1, metallization is performed to form the reaction layer 23 containing Ti as the active metal on the surface 21aa of the ceramic member 21 in a first brazing step of brazing of the paste material 23a to the ceramic member 21. Regarding the paste material 23a, an organic binder of the paste material 23a is removed by incineration as a result of a heat treatment in the first brazing step. By doing so, in the process for producing the ceramic-metal bonding structure 20 of Comparative Example 1, the reaction layer 23 with good solderability relative to the brazing material 24 may be formed on the surface of the ceramic member 21. Note that the reaction layer 23 has a thickness of 30 μm in Comparative Example 1.

Next, in the process for producing the ceramic-metal bonding structure 20 of Comparative Example 1, the ceramic member 21 on which the reaction layer 23 is formed is taken out from the heating furnace 31. In the process for producing the ceramic-metal bonding structure 20 of Comparative Example 1, the metallic member 22 is placed on the ceramic member 21 on which the reaction layer 23 is formed, with a metal foil 24a of a silver solder (see FIG. 5D) in-between. Note that the Ag—Cu based alloy (Ag:Cu=18:7) is also used for the metal foil 24a as with the present embodiment.

Then, in the process for producing the ceramic-metal bonding structure 20 of Comparative Example 1, a heat treatment is performed in a reaction furnace 32 under a condition where the metallic member 22 is placed on the ceramic member 21 on which the reaction layer 23 is formed, with the metal foil 24a is in-between (see FIG. 5E). In the process for producing the ceramic-metal bonding structure 20 of Comparative Example 1, in a second brazing step, the metallic member 22 is brazed to the ceramic member 21 with the brazing material 24 formed by melting the metal foil 24a.

In the process for producing the ceramic-metal bonding structure 20 of Comparative Example 1, after completion of the second brazing step, the ceramic-metal bonding structure 20 is cooled and then taken out from the reaction furnace 32. Accordingly, the ceramic-metal bonding structure 20 which the ceramic member 21 with the reaction layer 23 and the metallic member 22 are bonded with the brazing material 24 can be produced (see FIG. 5F).

In the ceramic-metal bonding structure 20 of Comparative Example 1 formed as described above, two brazing steps which are the first brazing step and the second brazing steps are required. Moreover, in the process for producing the ceramic-metal bonding structure 20 of Comparative Example 1, it is necessary to perform the brazing step twice, and therefore it is difficult to decrease a total usage amount of the brazing material 24.

In contrast, in the process for producing the ceramic-metal bonding structure 10 of the present embodiment, the ceramic member 1, the metallic member 2 and the brazing material 4 in contact with the adhesive layer 3 containing the active metal are formed and bonded through one-time brazing step.

In the process for producing the ceramic-metal bonding structure 20 of Comparative Example 1, Ti contained in the reaction layer 23 as the active metal and Ni derived from the metallic member 22 may react inside the brazing material 24, and a resulting reaction mixture may be segregated, in the brazing step for brazing the ceramic member 21 and the metallic member 22. Regarding the ceramic-metal bonding structure 20 of Comparative Example 1, a segregation layer 24a1 of an intermetallic compound of Ti of the active metal and Ni derived from the metallic member 22 is present inside the brazing material 24 but has part exposed on a surface of the brazing material 24. The intermetallic compound may be, for example, composed of a Ti—Ni based compound such as Ti₂Ni, TiNi and Ni₃Ti. In the ceramic-metal bonding structure 20, bonding strength of the brazing material 24 may deteriorate in a region in which the segregation layer 24a1 is formed, or bonding strength in vicinity of an interface between the ceramic member 21 and the brazing material 24 may deteriorate because of a lack of the active metal reacting with the ceramic material for the ceramic member 21.

In contrast, in the ceramic-metal bonding structure 10 of the present embodiment, the brazing material 4 is in contact with the adhesive layer 3 and the bonding end 2b. In the ceramic-metal bonding structure 10 of the present embodiment, the intermetallic compound 4a1 as the segregation layer of metal is present inside the brazing material 4 so as to extend along the edge of the bonding end 2b of the metallic member 2. In the ceramic-metal bonding structure 10 of the present embodiment, the intermetallic compound 4a1 inside the brazing material 4 is not exposed on the surface of the brazing material 4. Regarding the ceramic-metal bonding structure 10, a reason for increase in the bonding reliability is not yet revealed. However it is considered that the brazing material 4 placed on the ceramic member 1 with the particular adhesive layer 3 in-between incorporates the intermetallic compound 4a1 having a predetermined shape therein and this leads to decrease in the stress inside the brazing material 4 and thereby decrease in the bonding reliability can be suppressed.

Moreover, according to the ceramic-metal bonding structure 10, even when a usage amount of the brazing material 4 is decreased, it is possible to suppress occurrence of shrinkage of a fillet 24b at part of the brazing material 24 which may be observed in the ceramic-metal bonding structure 20 of Comparative Example 1 (see an area surrounded by a broken line in FIG. 4). In the ceramic-metal bonding structure 10, occurrence of the shrinkage of the fillet 4b is suppressed, and thus it is possible to further improve bonding strength between the ceramic member 1 and the metallic member 2. Also, in the ceramic-metal bonding structure 10 of the present embodiment, the ceramic member 1 and the metallic member 2 are bonded, and thus it is possible to obtain a high airtightness at bonding point where the ceramic member 1 and the metallic member 2 are bonded.

Hereinafter, each component of the ceramic-metal bonding structure 10 of the present embodiment will be further described.

For example, the ceramic member 1 may be used at a high temperature over 1000° C. and has a high corrosion resistance to chemicals such as sulfuric acid, nitric acid, caustic soda and the like, an excellent thermal shock resistance, a low thermal expansion coefficient, a wear resistance and an electrical insulating properties. Therefore, the ceramic member 1 may be used, for example, as a casing for an electromagnetic relay, a vacuum switch or an electronic component, or the like. The ceramic member 1 may be formed into various shapes such as a flat plate shape and a hollow cylindrical or prism shape in accordance with the intended use. The ceramic member 1 is made of the oxide ceramic. The ceramic member 1 may be, for example, made of an alumina ceramic which is the oxide ceramic and contains alumina as a main component. The ceramic member 1 may be, for example, made of a ceramic material having a content by percentage of alumina being 92% as the alumina ceramic. A material for the ceramic member 1 is not limited to the ceramic material whose content by percentage of alumina is 92%. For example, a ceramic material whose content by percentage of alumina is equal to or more than 96% may be also used as the alumina ceramic for forming the ceramic member 1. The ceramic member 1 may contain, besides alumina, for example, silicon oxide, calcium oxide, magnesium oxide, barium oxide, boron oxide, zirconium oxide and the like. The ceramic member 1 includes the surface 1aa which is smooth. A smoothness of the surface 1aa of the ceramic member 1 may be improved by polishing and the like.

The metallic member 2 is bonded to the adhesive layer 3 on the ceramic member 1 by the brazing material 4. The metallic member 2 is made to come into contact with a part including the ceramic member 1. That is, the metallic member 2 is in contact with the brazing material 4 on the adhesive layer 3 formed on the ceramic member 1. Even when the metallic member 2 protrudes in a direction diagonal to the surface 1aa of the ceramic member 1, it is possible to ensure bonding strength between the metallic member 2 and the adhesive layer 3. It is preferable that a difference in a linear expansion coefficient between the ceramic member 1 and the metallic member 2 is relatively small so as to suppress occurrence of thermal stress between the ceramic member 1 and the metallic member 2. The metallic member 2 which is excellent in heat resistance and corrosion resistance may be used in accordance with the intended use of the ceramic-metal bonding structure 10. The metal material which is mainly made of Fe and contains Ni is used for the metallic member 2. In other words, the metallic member 2 is mainly made of Fe and contains Ni. Note that, the metallic member 2 is mainly made of Fe, which means that one of main components of components of the metal material of the metallic member 2 is Fe. With regard to the metallic member 2, metal material mainly made of Fe and contains Ni is preferably exemplified by an Fe—Ni alloy. A material for the metallic member 2 may be, for example, preferably the Fe—Ni alloy which contains equal to or less than 30% by weight of Ni. In a case where the metallic member 1 whose content by percent of alumina is 92% is used, when the metal material for the metallic member 2 is the Fe—Ni alloy which contains equal to or less than 30% by weight of Ni, the linear expansion coefficient of the ceramic member 1 is close to the linear expansion coefficient of metallic member 2, and thus it is possible to suppress breakage of or cracks on ceramics and the like. More specifically, the metal material for the metallic member 2 may be, for example, preferably the Fe—Ni—Co alloy whose main component is Fe. For example, the Fe—Ni—Co alloy for forming the metallic member 2 may be an Fe—Ni—Co alloy which contains 54% by weight of Fe, 29% by weight of Ni and 17% by weight of Co.

The adhesive layer 3 is used in order to improve bonding between the ceramic member 1 and the brazing material 4. The adhesive layer 3 contains the active metal. The active metal is capable of reacting with constituent elements of the ceramic material for the ceramic member 1. Ionization tendency of the active metal is preferably higher than that of main metal elements of the brazing material 4. For example, when the oxide ceramic is used as the ceramic material for the ceramic member 1, the active metal may preferably be a metal element such as Ti, Zr and Hf.

In the process for producing the ceramic-metal bonding structure 10, for example, when Ti is used as the active metal, Ti contained in the paste material 3a which is the basis of the adhesive layer 3 reacts with O (oxygen) contained in the ceramic material for the ceramic member 1. In the ceramic-metal bonding structure 10 of the present embodiment, the brazing material 4 has solderability to the adhesive layer 3 which is higher than solderability to the ceramic member 1. Therefore, according to the process for producing the ceramic-metal bonding structure 10, it is possible to improve bonding strength between the brazing material 4 and the ceramic member 1. In the ceramic-metal bonding structure 10 of the present embodiment, the adhesive layer 3 and the brazing material 4 may be formed by one time heat treatment.

When a content of the active metal contained in the adhesive layer 3 is too small, reaction of the active metal with the ceramic material (the oxide ceramic) for the ceramic member 1 tends to be insufficient. In contrast, when the active metal contained in the adhesive layer 3 is too much, the intermetallic compound 4a1 inside the brazing material 4 is liable to grow, and thus bonding strength tends to deteriorate. The active metal contained in the adhesive layer 3 may be, for example, Ti which has good junction characteristics to the oxide ceramic preferably. Moreover, it is preferable that the paste material 3a which is the basis of the adhesive layer 3 contains the powder of TiH₂ so as to increase a reaction of Ti with the ceramic material for the ceramic member 1. When the paste material 3a which is the basis of the adhesive layer 3 contains the powder of TiH₂, the adhesive layer 3 can suppress oxidation or nitridization of Ti.

In the process for producing the ceramic-metal bonding structure 10 of the present embodiment, in the brazing step, the adhesive layer 3 is formed by use of the paste material 3a formed by the screen printing. In the present embodiment, the paste material 3a contains the powder of TiH₂. The powder of TiH₂ used in the present embodiment has the average particle size of equal to or less than 10 μm. In the process for producing the ceramic-metal bonding structure 10 of the present embodiment, hydride of Ti which is the active metal is used, and therefore it is possible to suppress the heat treatment in the brazing step from causing the oxidation of Ti. Also, in the process for producing the ceramic-metal bonding structure 10 of the present embodiment, the oxidation of Ti which is the active metal is suppressed, and therefore it is possible to improve the solderability of the brazing material 4 to the part containing the ceramic member 1. Moreover, in the process for producing the ceramic-metal bonding structure 10 of the present embodiment, the paste material 3a is applied by screen printing, and therefore the paste material 3a which is the basis of the adhesive layer 3 can be formed uniformly on the whole of the surface 1 aa of the ceramic member 1. In the process for producing the ceramic-metal bonding structure 10 of the present embodiment, uniformity in the solderability of the brazing material 4 to the ceramic member 1 may be improved. the process for producing the ceramic-metal bonding structure 10 of the present embodiment is not limited to a process including the step of forming the paste material 3a uniformly on the whole of the surface 1 aa of the ceramic member 1. In the process for producing the ceramic-metal bonding structure 10, when viewed from a cross section, the paste material 3a may be thickest at a center part of the ceramic member 1 on which the end 2b of the metallic member 2 is placed and may become thinner toward a peripheral part of the ceramic member 1. In the process for producing the ceramic-metal bonding structure 10, when the thickness of the paste material 3a is the thickest at the center part and becomes thinner toward the peripheral part, it is possible to relieve stress which occurs in the brazing material 4 during brazing.

In the process for producing the ceramic-metal bonding structure 10 of the present embodiment, the paste material 3a preferably contains 25% to 35% by weight of a powder of TiH₂. In the process for producing the ceramic-metal bonding structure 10, when the paste material 3a contains 25% to 35% by weight of TiH₂, it is possible to suppress partial shrinkage of the fillet 4b of the brazing material 4 and to facilitate formation of the fillet 4b of the brazing material 4. In the process for producing the ceramic-metal bonding structure 10 of the present embodiment, the paste material 3a contains 25% to 35% by weight of TiH₂, and therefore the produced ceramic-metal bonding structure 10 has the improved solderability of the brazing member 4 to the part including the ceramic member 1 and the fine shape of the fillet 4b of the brazing member 4.

In the process for producing the ceramic-metal bonding structure 10, when the paste material 3a contains less than 25% by weight of TiH₂, it tends to be difficult to control viscosity of the paste material 3a. Also, in the process for producing the ceramic-metal bonding structure 10, when the paste material 3a contains less than 25% by weight of TiH₂, dispersibility of the powder of TiH₂ deteriorates, and it tends to be difficult to form the paste material 3a uniformly on the surface 1 aa of the ceramic member 1. As a result, in the process for producing the ceramic-metal bonding structure 10, the solderability of the brazing material 4 to the part containing the ceramic member 1 tends to deteriorate.

In the process for producing the ceramic-metal bonding structure 10, when the paste material 3a contains more than 35% by weight of TiH₂, Ti being the active metal and Ni derived from the metallic member 2 react with each other inside the brazing material and this leads to segregation, and an amount of precipitation of the intermetallic compound 4a1 inside the brazing material 4 tends to increase excessively. In the process for producing the ceramic-metal bonding structure 10, when the paste material 3a contains more than 35% by weight of TiH₂, the precipitation amount of the intermetallic compound 4a1 is large and thus the intermetallic compound 4a1 tends to be exposed on the surface of the brazing material 4.

As a result, in the process for producing the ceramic-metal bonding structure 10, when the paste material 3a contains more than 35% by weight of TiH₂, it is considered that bonding strength of the brazing material 4 tends to deteriorate.

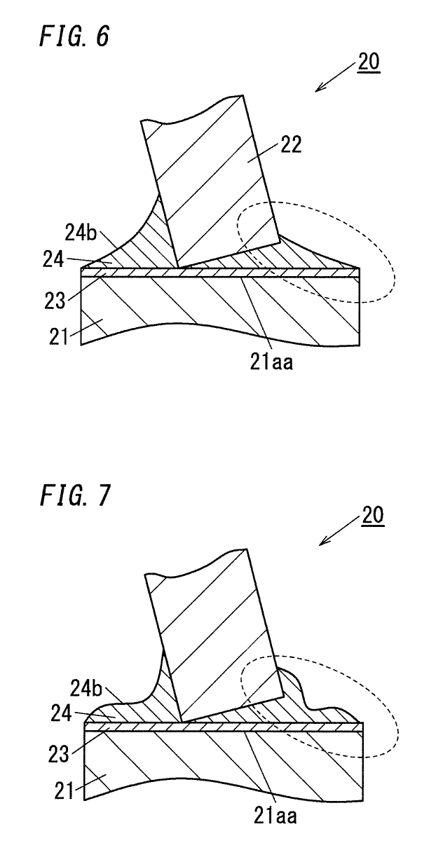

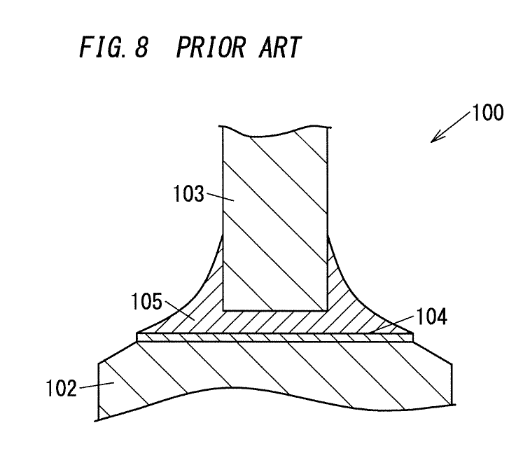

Hereinafter, it will be explained that the ceramic-metal bonding structure 10 produced by the process for producing the ceramic-metal bonding structure 10 of the present embodiment has increased bonding reliability, with reference to Comparative Examples 2 and 3. The ceramic-metal bonding structure 20 of Comparative Example 2 shown in FIG. 6 is produced in the same manner as Comparative Example 1 except the metallic member 22 is provided inclined relative to a normal line of the surface 21aa of the ceramic member 21 and the paste material 23a contains 10% by weight of TiH₂. The ceramic-metal bonding structure 20 of Comparative Example 3 shown in FIG. 7 is produced in the same manner as Comparative Example 1 except the metallic member 22 is provided inclined relative to a normal line of the surface 21aa of the ceramic member 21 and the paste material 23a contains 65% by weight of TiH₂.

Compared with the process for producing the ceramic-metal bonding structure 10, in the process for producing the ceramic-metal bonding structure 20 of Comparative Example 2, a paste material (not shown) only contains 10% by weight of TiH₂. Therefore, the solderability of the brazing material 24 to the part including the ceramic member 21 tends to be insufficient.

Therefore, when the ceramic-metal bonding structure 20 is produced by use of the paste material which contains 10% by weight of TiH₂, the fillet 24b of the brazing material 24 in the ceramic-metal bonding structure 20 is likely to be partially shrink (see the area surrounded by the broken line in FIG. 6). Regarding the ceramic-metal bonding structure 20, when the partial shrinkage of the fillet 24b of the brazing material 24 occurs, it tends to be difficult to ensure an airtightness by the brazing material 24 serving as part at which the ceramic member 21 and the metallic member 22 are bonded.

Compared with the process for producing the ceramic-metal bonding structure 10, in the process for producing the ceramic-metal bonding structure 20 of Comparative Example 3, the paste material 23a contains 65% by weight of TiH₂, and thus the solderability of the brazing material 24 tends to be too high. When the solderability of the brazing material 24 is too high in the ceramic-metal bonding structure 20, it tends to be difficult for the brazing material 24 to climb up the metallic member 22.

Therefore, when the ceramic-metal bonding structure 20 is produced by use of the paste material which contains 65% by weight of TiH₂, the fillet 24b of the brazing material 24 in the ceramic-metal bonding structure 20 is likely to be small (see the area surrounded by the broken line in FIG. 7). Moreover, regarding the ceramic-metal bonding structure 20, when the ceramic-metal bonding structure 20 is produced by use of the paste material which contains 65% by weight of TiH₂, an excessive amount of an intermetallic compound (not shown) is formed inside the brazing material 24, and thus the intermetallic compound is likely to be exposed on a surface of the brazing material 24. Regarding the ceramic-metal bonding structure 20, when an excessive amount of the intermetallic compound is formed inside the brazing material 24, the bonding strength of the brazing material 24 tends to decrease. As a result, in the ceramic-metal bonding structure 20 of Comparative Example 3, when the ceramic-metal bonding structure 20 is used for sealing, reliability is likely to deteriorate.

In view of the above, in the process for producing the ceramic-metal bonding structure 10 of the present embodiment, it is preferable that the paste material 3a contains 25% to 35% by weight of the powder TiH₂.

The brazing material 4 is capable of bonding the adhesive layer 3 on the ceramic member 1 and the metallic member 2. A material for the brazing material 4 may be selected appropriately in accordance with materials for the ceramic member 1, the metallic member 2 and the adhesive layer 3. The metal material 4a which is the basis of the brazing material 4 may be, for example, the Ag—Cu based alloy. The brazing material 4 may be the Ag—Cu alloy or an Ag—Cu alloy containing Sn. Alternatively, the brazing material 4 may be an Ag—Cu alloy containing Li. It is more preferable that the brazing material 4 has a fillet shape as to cover the bonding end 2b of the metallic member 2 and flare toward the ceramic member 1 from the metallic member 2.

The brazing material 4 may be, preferably, made of the metal material 4a which is excellent in solderability or affinity to the active metal of the adhesive layer 3 and has a similar composition to the active metal of the adhesive layer 3. The metal material 4a of the Ag—Cu based alloy has a relatively low melting point and good bonding properties to the metallic member 2.

In the ceramic-metal bonding structure 10 of the present embodiment, the bonding end 2b of the metallic member 2 is formed into a convex shape protruding toward the ceramic member 1 and a curved surface shape bulging toward an outside. In the ceramic-metal bonding structure 10, the bonding end 2b is in the curved surface shape bulging toward the outside, and thus it is possible to improve solderability of the metallic member 2 to the brazing material 4. Regarding the ceramic-metal bonding structure 10, the bonding end 2b is in the curved surface shape bulging toward the outside, which makes it possible to improve the solderability of the metallic member 2 to the brazing material 4, and thus it is possible to suppress partial shrinkage of the fillet 4b of the brazing material 4.

Note that, in the ceramic-metal bonding structure 10 of the present embodiment, a shape of the bonding end 2b is not limited to the curved surface shape bulging toward the outside but the bonding end 2b may be in a shape of tapering towards the ceramic member 1 and includes a plane surface (e.g., a plane surface facing the ceramic member 1). In the ceramic-metal bonding structure 10 of the present embodiment, when the bonding end 2b is in shape of tapering towards the ceramic member 1 and includes the plane surface, it is possible to improve the solderability of the metallic member 2 to the brazing material 4. Regarding the ceramic-metal bonding structure 10, the bonding end 2b includes the plane surface, which makes it possible to improve the solderability of the metallic member 2 to the brazing material 4, and thus it is possible to suppress partial shrinkage of the fillet 4b of the brazing material 4.

In summary, the ceramic-metal bonding structure 10 of one embodiment according to the present invention is the ceramic-metal bonding structure 10 in which a ceramic member 1 and a metallic member 2 are bonded by a brazing material 4. The ceramic member 1 is made of oxide ceramic. The metallic member 2 is mainly made of Fe and contains Ni. Formed on the surface of the ceramic member 1 is an adhesive layer 3 for bonding the ceramic member 1 and the brazing member 4. The adhesive layer 3 contains an active metal capable of reacting with the oxide ceramic. The adhesive layer 3 has a thickness of equal to or less than 1.5 μm. The brazing material 4 is in contact with the adhesive layer 3 and the end 2b of the metallic member 2. The ceramic-metal bonding structure 10 includes an intermetallic compound 4a1 of the active metal and Ni which is present inside the brazing material 4 so as to extend along an edge of a bonding end 2b.

In the ceramic-metal bonding structure 10, it is preferable that the metallic member 2 is made of a Fe alloy which contains equal to or less than 30% by weight of Ni.

In other words, the ceramic-metal bonding structure 10 of the present embodiment includes the following first feature.

In the first feature, the ceramic-metal bonding structure 10 includes: a ceramic member 1 of oxide ceramic; a metallic member 2 which is mainly made of Fe and contains Ni and includes an end 2b; an adhesive layer 3 formed on the ceramic member 1; and a brazing material 4 bonding the adhesive layer 3 and the end 2b of the metallic member 2. The adhesive layer 3 contains an active metal capable of reacting with the oxide ceramic and having a thickness of equal to or less than 1.5 μm. An intermetallic compound 4a1 of the active metal and the Ni exists inside the brazing material 4 so as to be between the adhesive layer 3 and the end 2b of the metallic member 2.

Moreover, the ceramic-metal bonding structure 10 of the present embodiment optionally includes the following second feature.

In the second feature, the metallic member 2 is made of a Ni—Fe alloy which contains equal to or less than 30% by weight of Ni.

Moreover, the process for producing the ceramic-metal bonding structure 10 of one embodiment according to the present invention is the process for producing the ceramic-metal bonding structure 10 including bonding a ceramic member 1 of oxide ceramic and a metallic member 2 which is mainly made of Fe and contains Ni, by a brazing material 4. The process includes: an applying step of applying a paste material 3a containing an active metal capable of reacting with the oxide ceramic to the ceramic member 1; a placing step of placing an end 2b of the metallic member 2 on the paste material 3a applied to the ceramic member 1 while the metal material 4a containing Ag is present between the end 2b and the paste material 3a; and subsequent to the placing step, a brazing step of bonding the adhesive layer 3 on the ceramic member 1 and the bonding end 2b of the metallic member 2b by forming the adhesive layer 3 to bond the ceramic member 1 and brazing material 4 by diffusing the active metal contained in the paste material 3a into the oxide ceramic, and melting the metal material 4a, by heating under reduced pressure atmosphere.

In the process for producing the ceramic-metal bonding structure 10, the paste material 3a contains a powder of the active metal which has an average particle size of equal to or less than 10 μm. In the applying step, it is preferable that the paste material 3a is applied to the ceramic member 1 so as to form a layer having a thickness of equal to or less than 20 μm.

In the process for producing the ceramic-metal bonding structure 10, it is preferable that the active metal is any one of Ti, Zr and Hf.

In the process for producing the ceramic-metal bonding structure 10, it is preferable that the paste material 3a contains 25% to 35% by weight of TiH₂.

In the process for producing the ceramic-metal bonding structure 10, in the brazing step, it is preferable that the paste material 3a and the metal material 4a are heated under reduced pressure atmosphere of equal to or less than 10⁻¹ Pa at a temperature in a range of 800° C. to 850° C.

In the process for producing the ceramic-metal bonding structure 10, in the brazing step, the ceramic member 1 and the metallic member 2 are brazed by the brazing material 4 including the intermetallic compound 4a1 of the active metal and Ni derived from the metallic member 2.

In other words, the process for producing the ceramic-metal bonding structure 10 of the present embodiment includes the following third feature.

In the third feature, the process for producing a ceramic-metal bonding structure 10 includes a preparation step, an applying step, a placing step and a brazing step. In the preparation step, a ceramic member 1 of oxide ceramic, a paste material 3a containing an active metal capable of reacting with the oxide ceramic, a metallic member 2 which is mainly made of Fe and contains Ni, and a metal material 4a containing Ag are prepared. In the applying step, the paste material 3a is applied to the ceramic member 1. In the placing step, the metal material 4a is placed on the paste material 3a and an end 2b of the metallic member 2 is placed on the metal material 4a. In the brazing step, the adhesive layer 3 and the end 2b of the metallic member 2 are bonded, by forming: an adhesive layer 3 on the ceramic member 1 by reacting the active metal contained in the paste material 3a with the oxide ceramic; and the brazing material 4 by melting the metal material 4a, by heating under reduced pressure.

Moreover, the process for producing the ceramic-metal bonding structure 10 of the present embodiments optionally includes the following fourth feature in addition to the third feature.

In the fourth feature, the paste material 3a contains a powder of the active metal which has the average particle size of equal to or less than 10 μm. In the applying step, the paste material 3a is applied to the ceramic member 1 so as to form a layer having a thickness of equal to or less than 20 μm.

Moreover, the process for producing a ceramic-metal bonding structure 10 of the present embodiment optionally includes the following fifth feature in addition to the third feature. The process for producing the same having the third and fifth features may further includes the fourth feature.

In the fifth feature, the active metal is any one of Ti, Zr and Hf.

Moreover, the process for producing a ceramic-metal bonding structure 10 of the present embodiment optionally includes the following sixth feature in addition to the third feature. The process for producing the same having the third and sixth features may further includes the fourth feature.

In the sixth feature, the paste material 3a contains 25% to 35% by weight of TiH₂.

Moreover, the process for producing a ceramic-metal bonding structure 10 of the present embodiment optionally includes the following seventh feature in addition to the third feature.

The process for producing the same having the third and the seventh features may further includes any one or more of the fourth to sixth features.

In the seventh feature, in the brazing step, the paste material 3a and the metal material 4a are heated under a pressure of equal to or less than 10⁻¹ Pa at a temperature in a range of 800° C. to 850° C.

Moreover, the process for producing a ceramic-metal bonding structure 10 of the present embodiment optionally includes the following eighth feature in addition to the third feature. The process for producing the same having the third and eighth features may further includes any one or more of the fourth to seventh features.

In the eighth feature, in the brazing step, heating is conducted so as to form an intermetallic compound 4a1 of the active metal and Ni derived from the metallic member 2 inside the brazing material 4 so as to be between the ceramic member 1 and the metallic member 2.

Therefore, the ceramic-metal bonding structure 10 of one embodiment according to the present invention can be higher in the bonding reliability.

Moreover, the process for producing a ceramic-metal bonding structure 10 of one embodiment according to the present invention can produce the ceramic-metal bonding structure 10 higher in the bonding reliability.

1. A ceramic-metal bonding structure comprising:
a ceramic member of an oxide ceramic;
a metallic member which is mainly made of Fe and contains Ni and includes an end;
an adhesive layer formed on the ceramic member; and
a brazing material bonding the adhesive layer and the end of the metallic member,
the adhesive layer containing an active metal capable of reacting with the oxide ceramic and having a thickness of equal to or less than 1.5 μm, and
an intermetallic compound of the active metal and the Ni existing inside the brazing material so as to be between the adhesive layer and the end of the metallic member.

2. The ceramic-metal bonding structure according to claim 1, wherein
the metallic member is made of a Fe—Ni alloy which contains equal to or less than 30% by weight of Ni.

3. A process for producing a ceramic-metal bonding structure comprising:
a preparation step for preparing a ceramic member of an oxide ceramic, a paste material containing an active metal capable of reacting with the oxide ceramic, a metallic member which is mainly made of Fe and contains Ni, and a metal material containing Ag;
an applying step of applying the paste material to the ceramic member;
a placing step of placing the metal material on the paste material and an end of the metallic member on the metal material; and
a brazing step for bonding the adhesive layer and the end of the metallic member, by forming: an adhesive layer on the ceramic member by reacting the active metal contained in the paste material with the oxide ceramic; and a brazing material by melting the metal material, by heating under reduced pressure.

4. The process for producing a ceramic-metal bonding structure according to claim 3, wherein:
the paste material contains a powder of the active metal which has an average particle size of equal to or less than 10 μm; and
in the applying step, the paste material is applied to the ceramic member so as to form a layer having a thickness of equal to or less than 20 μm.

5. The process for producing a ceramic-metal bonding structure according to claim 3, wherein
the active metal is any one of Ti, Zr and Hf.

6. The process for producing a ceramic-metal bonding structure according to claim 3, wherein
the paste material contains 25% to 35% by weight of TiH₂.

7. The process for producing a ceramic-metal bonding structure according to claim 3, wherein
in the brazing step, the paste material and the metal material are heated under a pressure of equal to or less than 10⁻¹ Pa at a temperature in a range of 800° C. to 850° C.

8. The process for producing a ceramic-metal bonding structure according to claim 3, wherein
in the brazing step, heating is conducted so as to form an intermetallic compound of the active metal and Ni derived from the metallic member inside the brazing material so as to e between the ceramic member and the metallic member.
